(19) United States
(12) Patent Application Publication
(10) Pub. No.: US 2026/0194165 A1
(43) Pub. Date: Jul. 9, 2026

(54) HEIGHT-ADJUSTABLE CONDUIT CLIP

(71) Applicant: GM GLOBAL TECHNOLOGY OPERATIONS LLC, Detroit, MI (US)

(72) Inventors: Myungcheol Kim, Incheon (KR); Minhyung Kang, Bucheon-si (KR); Namseuck Kwon, Incheon (KR)

(73) Assignee: GM GLOBAL TECHNOLOGY OPERATIONS LLC, Detroit, MI (US)

(21) Appl. No.: 19/014,671

(22) Filed: Jan. 9, 2025

(51) Int. Cl. F16L 3/205; F16L 3/02; F16L 3/22

(52) U.S. Cl. CPC F16L 3/205; F16L 3/02; F16L 3/221

(57) ABSTRACT

A height-adjustable conduit clip includes a clip base defining first and second portions, wherein the first portion is configured to fixedly engage a fastener. The conduit clip also includes a clip body having a first end defining conduit receptacle(s) and a second end configured to fixedly engage the second portion of the clip base to establish a height of the clip body first end relative to the clip base first portion. The conduit clip additionally includes a resilient member arranged between the clip base and the clip body and configured to preload the clip body away from the clip base when the clip body second end is engaged with the clip base second portion. The resilient member thereby secures the established height of the first end of the clip body relative to the first portion of the clip base.

### INTRODUCTION

The disclosure relates to a height-adjustable clip for a conduit, such as a pipe or a cable in a motor vehicle.

In mechanical engineering, a clip or bracket is an intermediate component for mounting or fixing one part to another. Clips are typically used to support smaller or more flexible components relative to larger, stronger, and/or more rigid structures to maintain the smaller components' spatial positioning, as well as dimensional and structural integrity.

In motor vehicles, conduits are employed to provide electrical and mechanical communication between systems and components. For example, conduits may convey electrical signals for communication between and control of electronic components or fluids for actuating/lubricating/cooling mechanical components. Electrical conduits may be configured as wiring cables, while mechanical conduits may be constructed from rigid or flexible tubing or piping, to transfer the corresponding working medium between and around various vehicle components and structures.

Various clips are used in motor vehicles to securely hold such conduits in place relative to the vehicle structure. Such clips prevent conduit movement, chafing, and potential damage by keeping the conduit from rubbing against other components. Multiple clips may be used to fix an individual conduit to maintain a prescribed conduit arrangement relative to the vehicle structure.

### SUMMARY

A height-adjustable conduit clip includes a clip base defining a first portion and a second portion, wherein the first portion is configured to fixedly engage a fastener. The height-adjustable conduit clip also includes a clip body having a first end defining at least one conduit receptacle and a second end configured to fixedly engage the second portion of the clip base. Engagement of the second end with the second portion of the clip base establishes a height of the first end of the clip body relative to the first portion of the clip base. The height-adjustable conduit clip additionally includes a resilient member arranged between the clip base and the clip body and configured to preload the clip body away from the clip base when the second end of the clip body is engaged with the second portion of the clip base. The resilient member thereby secures the established height of the first end of the clip body relative to the first portion of the clip base.

The second portion of the clip base may include external base serrations, while the second end of the clip body may include internal body serrations. In such an embodiment, the external base serrations, via application of force, engage the internal body serrations to establish the height of the first end of the clip body relative to the first portion of the clip base.

The resilient member may have a first end, a second end, and a height. The clip base may additionally define a pocket configured to receive the first end of the resilient member and provide a reaction surface therefor. The pocket may also position and guide the resilient member.

The second end of the clip body may additionally define a stepped outer wall configured to receive the second end of the resilient member and provide a force application surface therefor.

The stepped outer wall of the clip body may be configured to slidingly engage the pocket of the clip base.

The first portion of the clip base may define a bore with extensions configured to threadedly engage the fastener.

Each of the clip base and the clip body may be constructed from a polymeric material.

The polymeric material of the clip base may be either polyamide PA-12 or polyamide PA-66.

The polymeric material of the clip body may be either polyamide PA-6 or polyamide PA-66.

The resilient member may be a coil spring, for example, constructed from stainless steel.

The clip body may additionally include a pilot feature configured to guide the clip body relative to the clip base during engagement of the second end of the clip body with the second portion of the clip base.

A motor vehicle having a vehicle body structure and at least one conduit configured to serve or operate a vehicle system is also disclosed.

The motor vehicle may include a powerplant mounted to the vehicle body structure and configured to generate powerplant torque for propulsion of the vehicle, at least one road wheel operatively connected to the powerplant, and a vehicle braking system. The braking system employs at least one friction brake actuated via a hydraulic fluid conveyed through an individual conduit serving as a brake line to decelerate a respective road wheel.

The motor vehicle also includes the height-adjustable conduit clip engaged with an elongated fastener mounted to the vehicle body structure to maintain position of at least one of the brake lines relative to the vehicle body structure.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic plan view of a motor vehicle having a number of vehicle systems mounted to the vehicle's body structure and multiple respective conduits configured to serve subject vehicle systems.

FIG. 2 is a schematic perspective view of a height-adjustable conduit clip mounted to the vehicle body structure securing one of the conduits shown in FIG. 1 and configured to maintain position of the conduit relative to the vehicle body structure, according to the disclosure.

FIG. 3 is a schematic cross-sectional view of the height-adjustable conduit clip shown in FIG. 2 being assembled and mounted to a fastener extending from the vehicle body structure, according to the disclosure.

FIG. 4 is a schematic cross-sectional view of the height-adjustable conduit clip shown in FIG. 2, illustrating the conduit being captured by the clip and the clip sandwiching a section of insulation with respect to the vehicle body structure, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion. Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims.

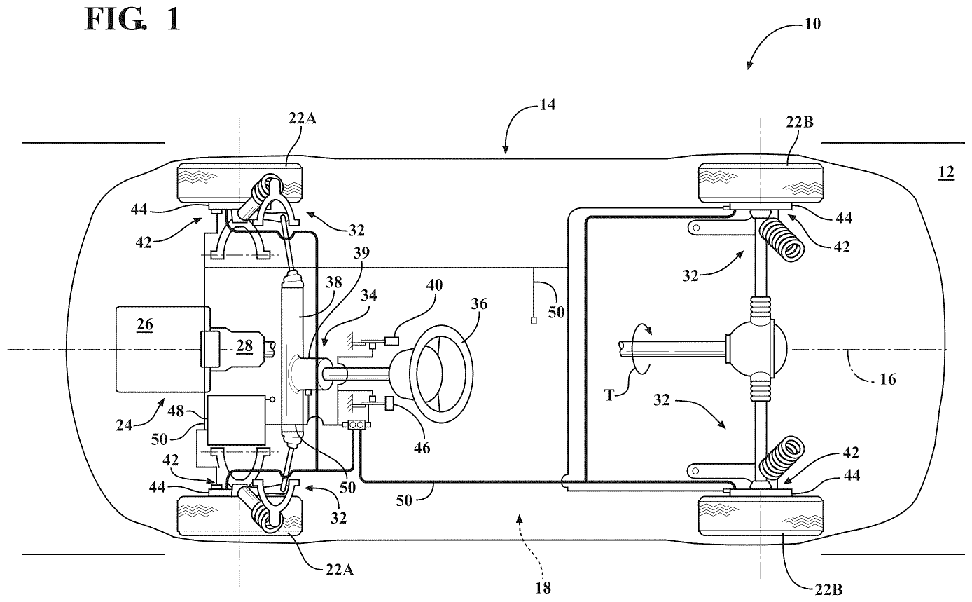

Referring to the drawings, wherein like reference numbers refer to like components, FIG. 1 shows a schematic view of a motor vehicle 10 positioned relative to a road surface 12. The vehicle 10 may be a mobile platform, such as a passenger vehicle, an all-terrain vehicle (ATV), an airplane, etc., used for personal, commercial, or industrial purpose. As shown, the vehicle 10 includes a vehicle body having a body structure 14 disposed along a longitudinal axis 16 and having respective left, right, front, and back sides. The vehicle body also defines a vehicle interior 18 configured to accommodate a vehicle operator, passengers, and cargo.

As shown in FIG. 1, the vehicle 10 includes a plurality of road wheels, specifically shown as front wheels 22A and rear wheels 22B. The vehicle 10 also includes a drivetrain 24 configured to provide propulsion thereof and mounted to the vehicle body structure 14. The drivetrain 24 includes one or more powerplants 26, such as a traction motor or electric motor-generator and/or an internal combustion engine, operatively connected to at least some of the road wheels 22A and 22B and configured to generate a powerplant or drive torque T for propulsion of the vehicle. As shown, the drivetrain 24 may additionally include a transmission assembly 28 operatively connecting the powerplant(s) 26 to at least some of the road wheels 22A and/or 22B for transmitting drive torque T thereto.

As also shown in FIG. 1, a vehicle suspension system 32 operatively connects the body structure 14 to the respective road wheels 22A and 22B for maintaining contact between the wheels and the road surface 12, and filtering road imperfections, and controlling vehicle handling. As further shown in FIG. 1, a vehicle steering system 34 is operatively connected to the front wheels 22A for steering the vehicle 10. The steering system 34 includes a steering wheel 36 that is operatively connected to the front wheels 22A via a steering rack 38 and may employ a power assist or booster 39 to reduce operator steering effort. The steering wheel 36 is arranged within the vehicle interior 18, such that an operator of the vehicle may command the vehicle to assume a particular direction with respect to the road surface 12. Additionally, an accelerator switch or pedal 40 is positioned within the vehicle interior 18. The accelerator switch 40 is operatively connected to the drivetrain 24, such as via a mechanical or an electrical cable, permitting the operator to command propulsion of the vehicle 10.

With continued reference to FIG. 1, a vehicle braking system 42 is operatively connected to the respective front and rear wheels, 22A and 22B respectively, for retarding rotation of the wheels and decelerating the vehicle 10. The braking system 42 includes a friction brake subassembly or friction brake 44 arranged at each of the respective front and rear wheels 22A, 22B and operatively connected to the vehicle suspension system 32. In other words, the braking system 42 may include a plurality of friction brake subassemblies 44. Each brake subassembly 44 may be actuated by a switch 46 (shown in FIG. 1), such as a brake pedal, configured to displace a hydraulic fluid conveyed from a master brake cylinder through individual conduits, i.e., brake pipes or lines. As shown, the brake switch 46, like the accelerator switch 40, is generally arranged within vehicle interior 18 and is adapted to be controlled by the operator of the vehicle 10.

Operating parameters of the drivetrain 24, suspensions 32, steering 34, and braking 42 systems may be generally stored in and/or regulated via a vehicle central processing unit (CPU) 48, with data signals and commands communicated therebetween through electrical cable(s) of a controller area network (CAN BUS). The CPU 48 may be programmed to coordinate generation of drive torque T via the drivetrain 24 with operation of the braking system 42, as well as with other vehicle systems described above. As shown in FIG. 1, vehicle 10 also includes a plurality of conduits configured to serve or operate various vehicle systems and generally indicated via numeral 50. An embodiment of the conduit 50 may be an electrical cable used to convey electrical signals for communication with and/or actuation of a particular vehicle system, while another embodiment of the conduit may be a pipe or a hose used to convey an appropriate fluid for actuation, cooling, and lubrication of the same or another vehicle system. The drivetrain 24, suspension 32, steering 34, and braking 42 systems may be representative of the vehicle systems employing conduits 50 for the above-described functions.

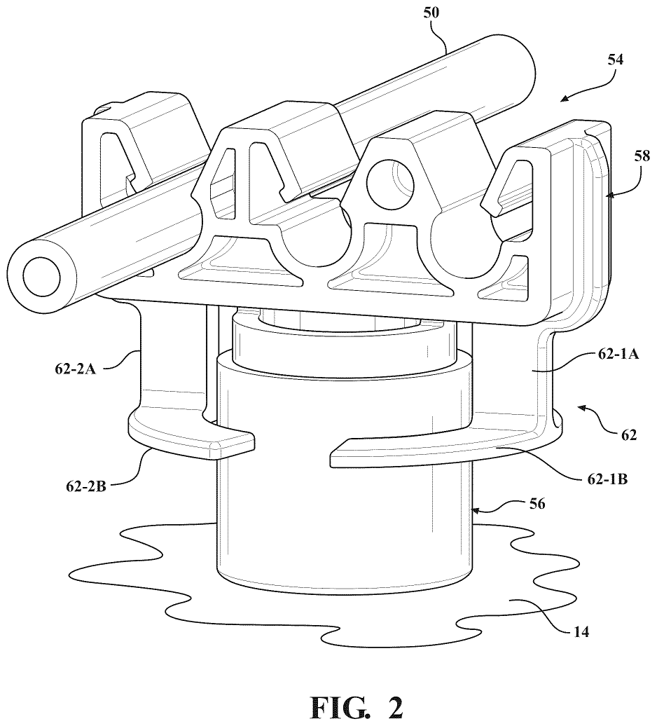

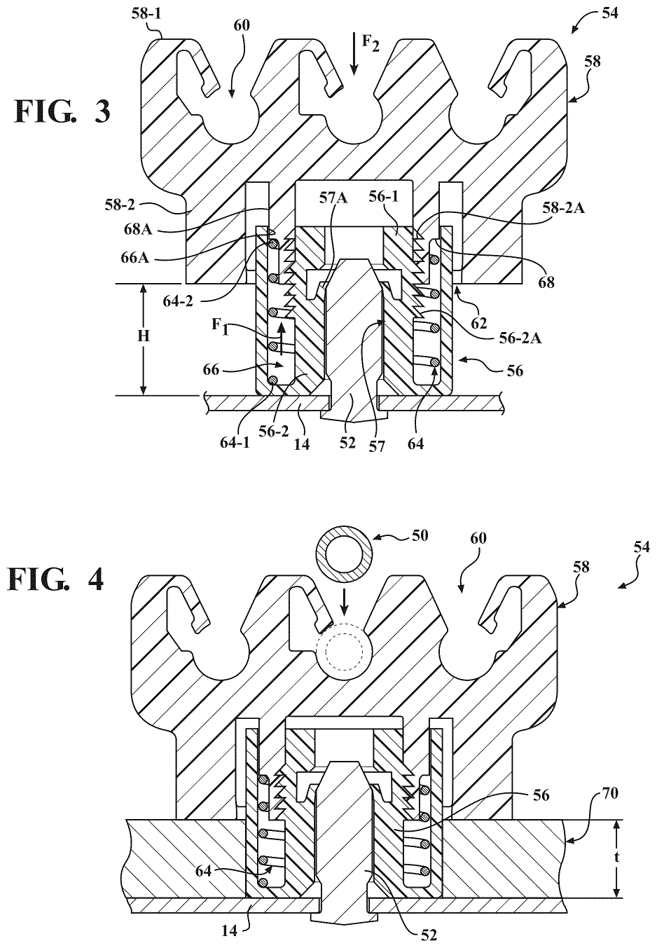

As shown in FIG. 3, vehicle body structure 14 typically includes elongated fasteners 52 extending therefrom. Fasteners 52 may be used to attach various vehicle components (not shown) to the vehicle body structure 14 and extend through a surface of the vehicle body structure on an opposite side of the attached component. Fasteners 52 may also be purposely positioned threaded studs for mounting clips and brackets. As shown in FIGS. 2-4, vehicle 10 includes one or more height-adjustable conduit clips 54, each engaged with a respective fastener 52 and thereby mounted to the vehicle body structure 14. Each height-adjustable conduit clip 54 is specifically configured to capture and maintain the position of at least one of the conduits 50 relative to the vehicle body structure 14.

With reference to FIG. 3, each height-adjustable conduit clip 54 includes a clip base 56 having a generally cylindrical shape and defining a first portion 56-1 and a second portion 56-2. The first portion 56-1 is configured to fixedly engage, such as by being screwed onto, the fastener 52. The first portion 56-1 of the clip base may define a bore 57 with extensions 57A configured to threadedly engage the fastener 52 for mounting the height-adjustable conduit clip 54 to the vehicle body structure 14. Each height-adjustable conduit clip 54 also includes a clip body 58 having a first end 58-1 defining at least one conduit receptacle 60. The conduit receptacle 60 may be configured as a snap-in resilient holder for corresponding conduit(s), e.g., a brake line or an electrical cable.

As shown in FIG. 3, the clip body 58 also includes a second end 58-2 configured to fixedly engage the second portion 56-2 of the clip base 56, thereby establishing a height H of the clip body first end 58-1 relative to the first portion 56-1 of the clip base. The clip body 58 may additionally include a pilot feature 62 arranged externally with respect to the clip base 56. Pilot feature 62 is configured to guide the clip body 58 relative to the clip base 56 during engagement of the clip body second end 58-2 with the clip base second portion 56-2. The pilot feature 62 may include an unbroken annular structure (not shown). Alternatively, the pilot feature 62 may include two legs, such as a right or first leg 62-1A and a left or second leg 62-2A, connected to respective semicircular portions 62-1B and 62-2B (shown in FIG. 2) arranged externally with respect to the clip base 56 in an assembled clip 54. The two embodiments of the pilot feature 62 would be configured to accomplish an analogous result.

As shown in FIGS. 3 and 4, a resilient member 64 is arranged between the clip base 56 and the clip body 58. The resilient member 64 may be a coil spring constructed from stainless steel. The resilient member 64 is configured to preload the clip body 58 via a force F₁ (shown in FIG. 3) away from the clip base 56 when the second end 58-2 of the clip body 58 is engaged with the second portion 56-2 of the clip base 56. The subject preloading by the resilient member 64 secures the established height H of the clip body first end 58-1 relative to the clip base first portion 56-1 when the height-adjustable conduit clip 54 is mounted on the fastener 52 and the respective conduit(s) are clipped into the receptacle 60.

As shown, the resilient member 64 may have a first end 64-1, a second end 64-2, and a free height selected permit generation of significant force F₁ at initial engagement between clip base second portion 56-2 and clip body second end 58-2. The clip base 56 may additionally define a pocket 66 configured to receive the first end 64-1 of the resilient member and provide a reaction surface for the first end 64-1. The pocket 66 is further configured to position and guide the resilient member within the height-adjustable conduit clip 54. The second end 58-2 of the clip body 58 may further define a stepped outer wall 68 configured to receive the second end 64-2 of the resilient member 64 and establish a force application surface therefor. A surface 68A of the stepped outer wall 68 on the clip body second end 58-2 may slidingly engage a surface 66A of the clip base pocket 66 as the resilient member 64 is compressed during engagement of the clip base second portion 56-2 with the clip body second end 58-2.

The second portion 56-2 of the clip base may include external base serrations 56-2A, while the second end 58-2 of the clip body may include complementary internal body serrations 58-2A. The external base serrations 56-2A may be driven to engage the internal body serrations 58-2A via application of force F₂ and thereby establish the height H of the first end 58-1 of the clip body relative to the first portion 56-1 of the clip base. Each of the clip base 56 and the clip body 58 may be constructed from a polymeric material. The material of the clip base 56 may be generally selected to provide higher flexibility as compared to the material of the clip body to permit controlled deflection of the external base serrations 56-2A during their engagement with the internal body serrations 58-2A. Different grades of polyamide (PA) may be used for the clip base 56 and clip body 58. Specifically, either PA-12 or PA-66 may be used for the clip base 56, while either PA-6 or PA-66 may be used for the clip body 58. As understood, PA-66 generally offers higher rigidity and tensile strength than PA-6, while PA-12 provides better impact resistance and flexibility across the three materials.

The height-adjustable conduit clip 54 may be particularly beneficial in mounting conduit(s) 50 to the vehicle body structure 14 employing a heat shield or insulation 70 (shown in FIG. 4) having a high variation in thickness t. For example, if the insulation 70 is arranged next to or around the fastener 52, the length of the fastener extending beyond the insulation may be difficult to predetermine. In some situations, insulation 70 with a nominal thickness t higher than typical may also be used. In such a situation, a standard, fixed height clip may be too short to have sufficient engagement with the fastener 52 or may locally compress the insulation 70 and thereby generate an NVH (noise, vibration, and harshness) concern when the conduit(s) 50 are captured by the receptacle 60.

On the other hand, the first portion 56-1 of the clip base 56 may be fully engaged with the fastener 52 and then the clip body 58 may be pressed into fixed engagement with the second portion 56-2 of the clip base 56. Following such assembly of the height-adjustable conduit clip 54, the conduit(s) 50 may be snapped into the receptacle 60. The foregoing assembly of the clip base 56 and the clip body 58 establishes the appropriate height H of the clip body first end 58-1 relative to the clip base first portion 56-1, providing sufficient spacing for the insulation 70 under the conduit(s) 50. As a result, the height-adjustable conduit clip 54 permits consistent mounting of conduits to the vehicle body structure 14 while sandwiching thicker insulation or insulation with variable thickness.

In an exemplary application, the height-adjustable conduit clip 54 may be employed as part of the vehicle braking system 42. The height-adjustable conduit clip 54 may simultaneously accept and hold one or more brake lines, each an embodiment of the conduit 50, in place on the vehicle body structure 14, such as by attachment to the underside of the vehicle floor pan. In such usage, the height-adjustable conduit clip 54 may be identified as a height-adjustable brake line clip. Once anchored in place, and with the corresponding brake line(s) clipped in, the height-adjustable conduit clip 54 would prevent movement, chafing, and potential damage to the brake line(s) by keeping the line(s) from rubbing against nearby components and structures. A hydraulic brake fluid may then be conveyed through the brake line(s) for actuating respective friction brake(s) 44 while the clip(s) 54 maintain proper brake line routing for optimal hydraulic pressure transfer and brake line stability.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A height-adjustable conduit clip comprising:
a clip base defining a first portion and a second portion, wherein the first portion is configured to fixedly engage a fastener;
a clip body having a first end defining at least one conduit receptacle and a second end configured to fixedly engage the second portion of the clip base, thereby establishing a height of the first end of the clip body relative to the first portion of the clip base; and
a resilient member arranged between the clip base and the clip body and configured to preload the clip body away from the clip base when the second end of the clip body is engaged with the second portion of the clip base thereby securing the established height of the first end of the clip body relative to the first portion of the clip base.

2. The height-adjustable conduit clip according to claim 1, wherein:
the second portion of the clip base includes external base serrations;
the second end of the clip body includes internal body serrations; and
the external base serrations engage the internal body serrations to establish the height of the first end of the clip body relative to the first portion of the clip base.

3. The height-adjustable conduit clip according to claim 1, wherein the resilient member has a first end, a second end, and a height, and wherein the clip base additionally defines a pocket configured to receive the first end of the resilient member and provide a reaction surface therefor.

4. The height-adjustable conduit clip according to claim 3, wherein the second end of the clip body additionally defines a stepped outer wall configured to receive the second end of the resilient member and provide a force application surface therefor.

5. The height-adjustable conduit clip according to claim 4, wherein the stepped outer wall of the clip body is configured to slidingly engage the pocket of the clip base.

6. The height-adjustable conduit clip according to claim 1, wherein the first portion of the clip base defines a bore with extensions configured to threadedly engage the fastener.

7. The height-adjustable conduit clip according to claim 1, wherein each of the clip base and the clip body is constructed from a polymeric material.

8. The height-adjustable conduit clip according to claim 7, wherein the polymeric material of the clip base is one of polyamide PA-12 and PA-66.

9. The height-adjustable conduit clip according to claim 7, wherein the polymeric material of the clip body is one of polyamide PA-6 and PA-66.

10. The height-adjustable conduit clip according to claim 1, wherein the resilient member is a coil spring.

11. A motor vehicle comprising:
a vehicle body structure;
a vehicle system mounted to the vehicle body structure;
at least one conduit configured to serve or operate the vehicle system; and
a height-adjustable conduit clip engaged with an elongated fastener mounted to the vehicle body structure to maintain position of the at least one conduit relative to the vehicle body structure and including:
a clip base defining a first portion and a second portion, wherein the first portion is configured to fixedly engage the elongated fastener;
a clip body having a first end defining a receptacle for the at least one conduit and a second end configured to fixedly engage the second portion of the clip base, thereby establishing a height of the first end of the clip body relative to the first portion of the clip base; and
a resilient member arranged between the clip base and the clip body and configured to preload the clip body away from the clip base when the second end of the clip body is engaged with the second portion of the clip base thereby securing the established height of the first end of the clip body relative to the first portion of the clip base.

12. The motor vehicle according to claim 11, wherein:
the second portion of the clip base includes external base serrations;
the second end of the clip body includes internal body serrations; and
the external base serrations engage the internal body serrations to establish the height of the first end of the clip body relative to the first portion of the clip base.

13. The motor vehicle according to claim 11, wherein the resilient member has a first end, a second end, and a height, and wherein the clip base additionally defines a pocket configured to receive the first end of the resilient member and provide a reaction surface therefor.

14. The motor vehicle according to claim 13, wherein the second end of the clip body additionally defines a stepped outer wall configured to receive the second end of the resilient member and provide a force application surface therefor.

15. The motor vehicle according to claim 14, wherein the stepped outer wall of the clip body is configured to slidingly engage the pocket of the clip base.

16. The motor vehicle according to claim 11, wherein the first portion of the clip base defines a bore with extensions configured to threadedly engage the elongated fastener.

17. The motor vehicle according to claim 11, wherein each of the clip base and the clip body is constructed from a polymeric material.

18. The motor vehicle according to claim 17, wherein the polymeric material of the clip base is one of polyamide PA-12 and PA-66 and the polymeric material of the clip body is one of polyamide PA-6 and PA-66.

19. The motor vehicle according to claim 11, wherein the resilient member is a coil spring.

20. A motor vehicle comprising:
a vehicle body structure;
a powerplant mounted to the vehicle body structure and configured to generate powerplant torque for propulsion of the vehicle;
at least one road wheels operatively connected to the powerplant;
a braking system having at least one friction brake actuated via a hydraulic fluid conveyed through an individual brake line and configured to decelerate a respective road wheel; and
a height-adjustable brake line clip engaged with an elongated fastener mounted to the vehicle body structure to maintain position of at least one of the brake lines relative to the vehicle body structure and including:
a clip base defining a first portion and a second portion, wherein the first portion is configured to fixedly engage the elongated fastener;
a clip body having a first end defining at least one brake line receptacle for a respective brake line and a second end configured to fixedly engage the second portion of the clip base, thereby establishing a height of the first end of the clip body relative to the first portion of the clip base; and
a resilient member arranged between the clip base and the clip body and configured to preload the clip body away from the clip base when the second end of the clip body is engaged with the second portion of the clip base thereby securing the established height of the first end of the clip body relative to the first portion of the clip base.
